(19) United States
(12) Patent Application Publication
(10) Pub. No.: US 2015/0293808 A1
(43) Pub. Date: Oct. 15, 2015

(54) SOFT READ HANDLING OF READ NOISE

(71) Applicant: LSI Corporation, San Jose, CA (US)

(72) Inventors: Yunxiang Wu, Cupertino, CA (US); Yu Cai, San Jose, CA (US); Erich F. Haratsch, Bethlehem, PA (US)

(73) Assignee: LSI Corporation, San Jose, CA (US)

(21) Appl. No.: 14/249,450

(22) Filed: Apr. 10, 2014

(51) Int. Cl. G06F 11/07

(52) U.S. Cl. CPC G06F 11/0793; G06F 11/076

(57) ABSTRACT

Aspects of the disclosure pertain to methods and systems that are configured to handle excessive read noise in soft read systems. In an implementation, a method includes determining a number of unexpected patterns of a soft read of a memory cell after a soft decoding failure. The method also includes determining whether the number of unexpected patterns is greater than a threshold number of unexpected patterns. When it is determined that the number of unexpected patterns is greater than the threshold number of unexpected patterns, the method at least one of: performing at least one more soft read of the memory cell with a larger read voltage spacing than an initial read that produced the soft decoding failure; and discarding a result of one or more soft reads of the memory cell and utilizing a remainder of results of respective other soft reads of the memory.

### FIELD OF THE INVENTION

The present disclosure relates to systems and techniques for handing read noise in soft read systems.

### BACKGROUND

In data transmission systems, read noise can contribute errors to the transmission of a data stream over a communication channel. With aggressive process scaling, the effectiveness of raw bit error rate (BER) of flash memories is diminishing. To maintain reliability, solid-state drive (SSD) controllers adopt error correction codes with soft decoding capability, such as low density parity check (LDPC) codes. These codes are useful for correcting errors, but require soft input to the decoder. The soft input can be provided in the form of log likelihood ratio (LLR). Since conventional flash devices do not provide soft decision outputs, SSD controllers generate them using either hardware or software. Read noise is a type of read instability caused by the fluctuation of read current which is in turn caused by random telegraph noise due to trapping/releasing of electrons via floating gates of NAND flash. With increasing first program-erase (P/E) cycles, floating gates are gradually worn out and consequently the noise becomes more and more significant.

### SUMMARY

Aspects of the disclosure pertain to methods and systems that are configured to handle excessive read noise in soft read systems. In an implementation, a method includes determining a number of unexpected patterns of a soft read of a memory cell after a soft decoding failure. The method also includes determining whether the number of unexpected patterns is greater than a threshold number of unexpected patterns. When it is determined that the number of unexpected patterns is greater than the threshold number of unexpected patterns, the method at least one of: performing at least one more soft read of the memory cell with a larger read voltage spacing than an initial read that produced the soft decoding failure; and discarding a result of one or more soft reads of the memory cell and utilizing a remainder of results of respective other soft reads of the memory.

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner.

### BRIEF DESCRIPTION OF THE FIGURES

The Written Description is described with reference to the accompanying figures. Other embodiments of the invention will become apparent.

FIG. 1 is a schematic diagram of a memory device configured to utilize soft reads methods to handle read noise read in accordance with an example implementation of the present disclosure.

FIG. 2 is a chart illustrating read voltage, decision regions, and decision patterns for one read of least significant bit (LSB) pages in accordance with an example implementation of the present disclosure.

FIG. 3 is a chart illustrating read voltages, decision regions, and decision patterns for two reads of least significant bit (LSB) pages in accordance with an example implementation of the present disclosure.

FIG. 4 is a chart illustrating read voltages, decision regions, and decision patterns for three reads of least significant bit (LSB) pages in accordance with an example implementation of the present disclosure.

FIG. 5 is a plot illustrating the number of unexpected patterns for two to seven soft reads over various read voltage spacing with a first program-erase (P/E) cycle count.

FIG. 6 is a plot illustrating the number of unexpected patterns for two to seven soft reads over various read voltage spacing with a higher program-erase (P/E) cycle count than that of FIG. 5.

FIG. 7 is a flow diagram illustrating a method to reduce the impact of read noise on soft reads in accordance with an example implementation of the present disclosure.

FIG. 8 is a flow diagram illustrating a method to reduce the impact of read noise on soft reads in accordance with an example implementation of the present disclosure.

FIG. 9 is a schematic diagram of a controller in accordance with an example implementation of the present disclosure.

### WRITTEN DESCRIPTION

Referring to FIG. 1, a schematic diagram of a memory device 100 is shown in accordance with an example embodiment of the present disclosure. As shown, the memory device 100 includes a controller 102 communicatively coupled with a memory 104. The memory device 100 (e.g., a solid state drive (SSD)) is generally configured for soft read methods for handling excessive read noise. In embodiments, the controller 102 integrates a processor configured to implement error correction codes (ECC) with soft decoding capability, such as low density parity check (LDPC) codes. For example, the controller 102 applies a soft decoding algorithm to a hard decision (e.g., binary sequence) of the memory device 100 after a read operation of the memory 104 for error correction in order to convert the hard decision to log likelihood ratios (LLRs). In embodiments, memory 104 includes a flash memory, such as a NAND flash memory.

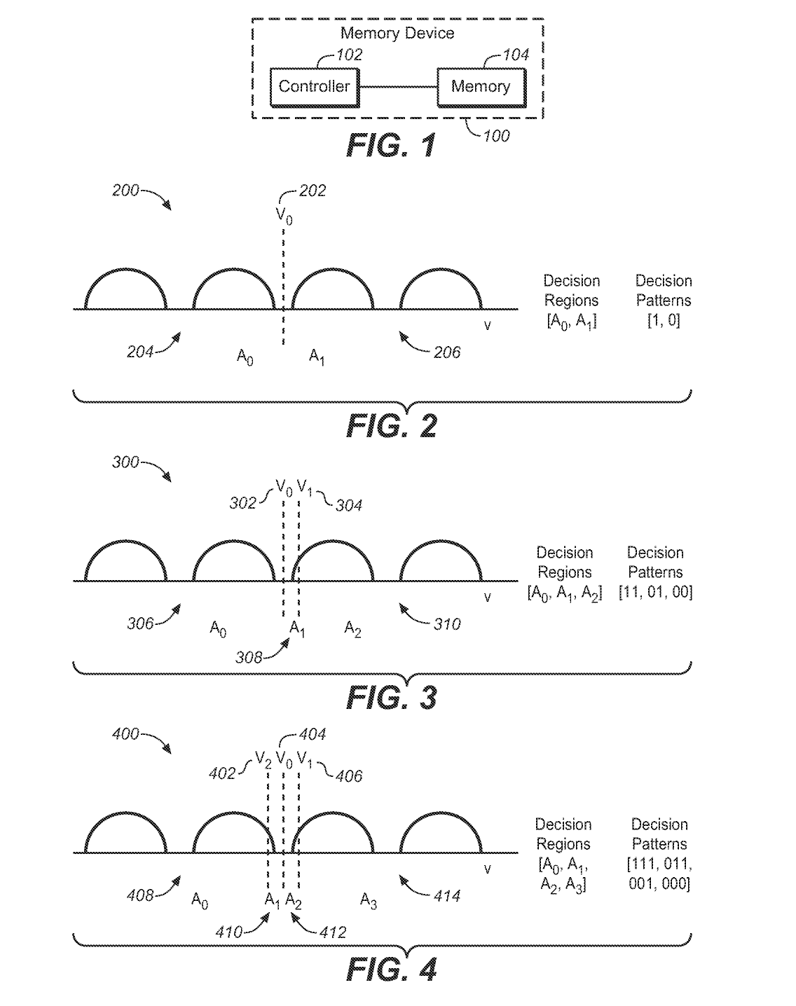

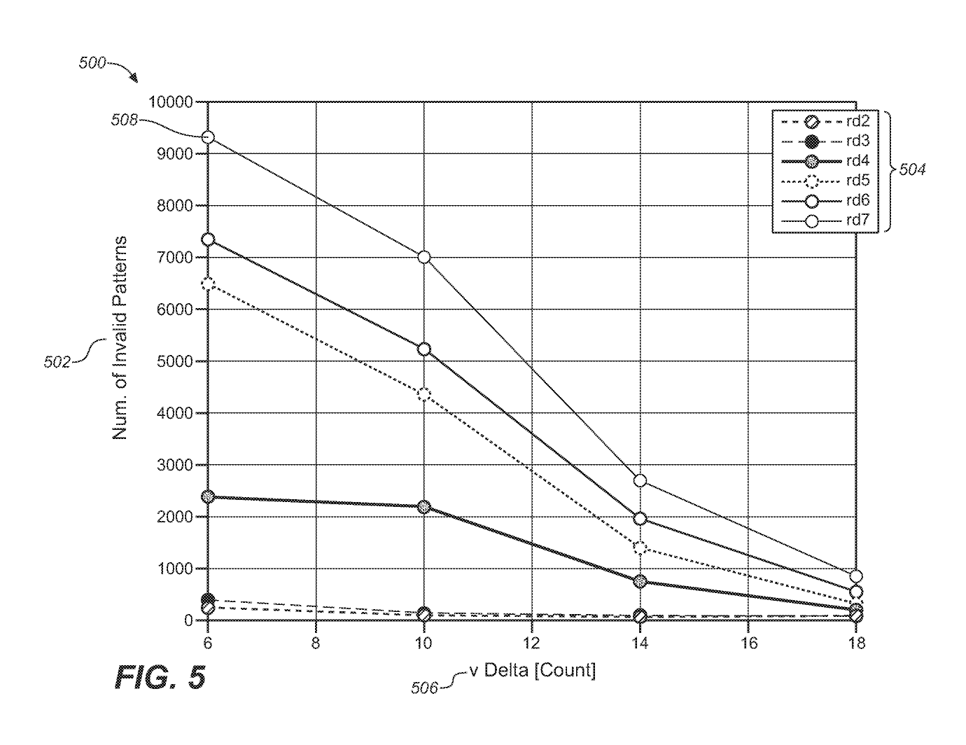

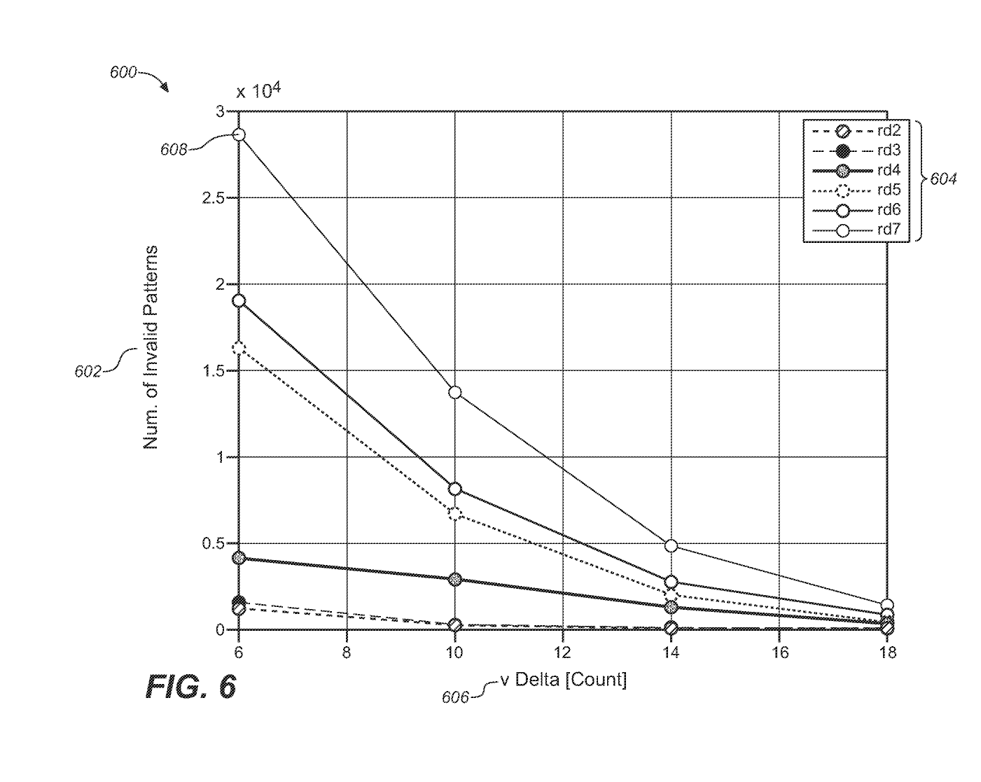

In embodiments, the memory device 100 includes multi-level cell (MLC) channels, where the LLR is a function of four charge-state distributions (e.g., means and variances) and read reference voltages (Vref). As such, the LLRs are generated with one or more reads with varying read reference voltages around cross-points of distributions (as shown in FIGS. 2-4). In embodiments, the controller 102 of the memory device 100 is configured to reduce degradation of performance of the soft decoder and to reduce the impact of read noise. Read noise makes some cells of an MLC unit randomly to be sensed as 1 or 0 with the same read reference voltage. The random flipping of a cell can create an unexpected pattern (FIGS. 5 and 6) for multiple soft reads. The read noise is correlated with the number of reads or close placement of read reference voltages.

Referring to FIGS. 2-4, charts are shown with read reference voltages (Vref), decision regions, and corresponding decision patterns for reading least significant bit (LSB) pages of MLC flash with read voltages. FIG. 2 provides a chart 200 with one read voltage, V₀ (202), which divides the voltage axis into two decision regions, shown as A₀ (204) and A₁ (206). The corresponding decision patterns for the chart 200 are 1 and 0 ([1,0]), which correspond to the two decision regions, 204 and 206.

FIG. 3 provides a chart 300 with two read voltages, V₀ (302) and V₁ (304), which divide the voltage axis into three decision regions, shown as A₀ (306), A₁ (308), and A₂ (310). The decision patterns for the chart 300 are 11, 01, and 00 ([11, 01, 00]), which correspond to the three decision regions, 306, 308, and 310.

FIG. 4 provides a chart 400 with three read voltages, V₀ (402), V₁ (404), and V₂ (406), which divide the voltage axis into four decision regions, shown as A₀ (408), A₁ (410), A₂ (412), and A₃ (414). The decision patterns for the chart 400 are 111, 011, 001, and 000 ([111, 011, 001, 0000]), which correspond to the four decision regions, 408, 410, 412, and 414.

In general, the number of decision patterns for a number N of read voltages is N+1 decision patterns. For a most significant bit (MSB) page (e.g., with Gray coding), there are a maximum of 2*N hard decision patterns since a pair of read voltages is used for each read. In FIGS. 2-4, effects of read noise are not shown. Read noise makes some cells of an MLC unit randomly to be sensed as 1 or 0 with the same read reference voltage, and as such, N reads of the cell will produce 2̂N possible patterns in the presence of read noise. The patterns that are produced in addition to the expected patterns are referred to as unexpected patterns. When the number of reads (N) is large, the number of unexpected patterns can exceed the number of expected patterns.

The number of unexpected patterns are counted or determined after each of the soft reads of a cell. FIG. 5 illustrates a plot 500 of number of unexpected patterns 502 for differing numbers of soft reads 504 for various read voltage spacing 506, where the read voltage spacing 506 refers to the difference in the read voltage value between two adjacent read voltages. The plot 500 of FIG. 5 provides an example embodiment with read voltage spacing of 6, 10, 14, and 18 units for two to seven soft reads of a tested cell having a program-erase (P/E) cycle count of about 3500. As shown in the figure, as the read voltage spacing 506 increases, the number of unexpected patterns 502 decreases for each of the number of soft reads 504. At seven reads, the maximum number of unexpected patterns 508 is about 9,200 for the cell. As also shown, as the number of soft reads 504 increases (e.g., increasing from two reads through seven reads), so too does the number of unexpected patterns 502.

The plot 500 is an example plot showing unexpected patterns of a cell having a particular P/E cycle count (e.g., 3500 for the cell read to provide the plot 500). The unexpected patterns number can differ between cells having different P/E cycle counts. For instance, referring to FIG. 6, a plot 600 illustrates the number of unexpected patterns 602 for two to seven soft reads 604 over various read voltage spacing 606 for a cell having a higher program-erase (P/E) cycle count than that of FIG. 5. The P/E cycle count for the cell tested for the plot 600 of FIG. 6 is about 5000, or about 1500 cycles more than for the cell tested for the plot 500 of FIG. 5. As shown in FIG. 6, the maximum number of unexpected patterns 608 is about 30,000 for seven soft reads of the cell. The trends of the plot 500 are also be seen in the plot 600, namely that as the read voltage spacing 606 increases, the number of unexpected patterns 602 decreases for each of the number of soft reads 604, and that as the number of soft reads 604 increases (e.g., increasing from two reads through seven reads), so too does the number of unexpected patterns 602.

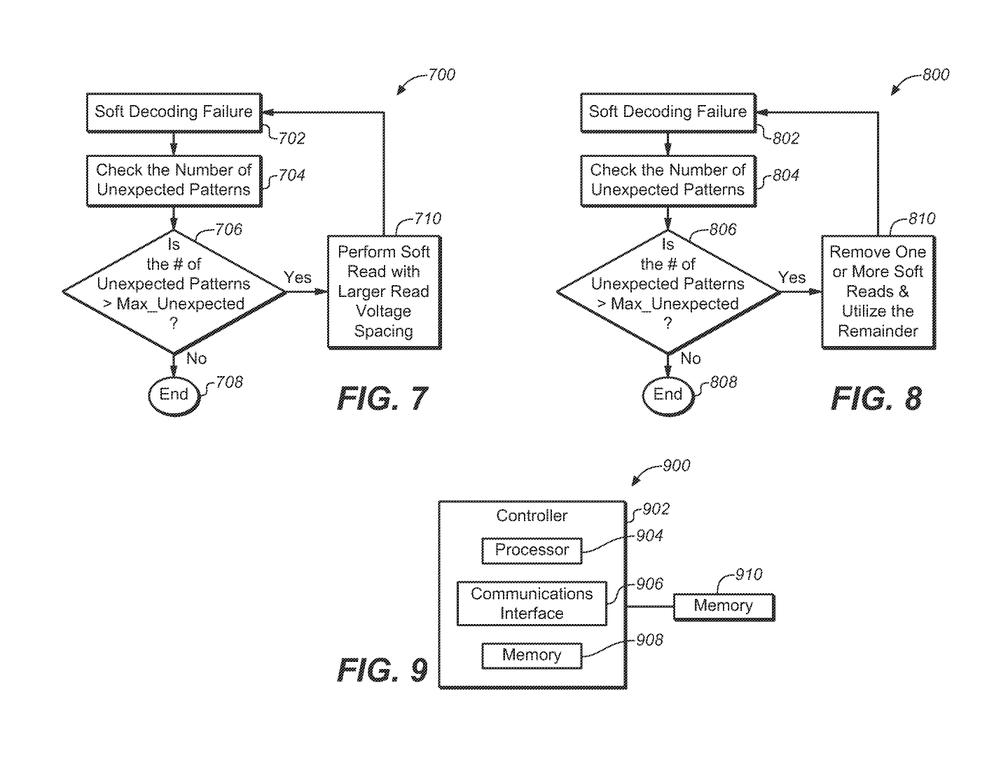

In embodiments, a threshold number of unexpected patterns is set for a particular LDPC code and decoder. For instance, simulations provide an option to determine the performance degradation caused by unexpected patterns (e.g., erasures) for a particular LDPC code and decoder. As such, in embodiments, a threshold MAX_UNEXPECTED is defined as the maximum tolerable number of unexpected patterns for the LDPC code and decoder. In embodiments, the threshold MAX_UNEXPECTED is a unique value for a particular LDPC code and decoder. The methods described herein below with regard to FIGS. 7 and 8 provide functionality to reduce the impact of read noise on the code/decoder system.

Referring to FIG. 7, a flow diagram 700 is shown illustrating a method to reduce the impact of read noise on soft reads in accordance with an example implementation of the present disclosure. The flow diagram 700 begins with block 702, which includes a soft decoding failure, such as by receiving an indication of a soft decoding failure, determining that a soft decoding failure has occurred, and the like. For example, the controller 102 determines that a soft decoding failure has occurred during a read process. From block 702, the flow proceeds to block 704, where the number of unexpected patterns is checked. From block 704, the flow proceeds to block 706, where it is determined whether the number of unexpected patterns is greater than MAX_UNEXPECTED (e.g., a maximum tolerable number of unexpected patterns for a particular LDPC code and decoder). When it is determined in block 706 that the number of unexpected patterns is less than MAX_UNEXPECTED, the flow proceeds to an end operation 708. When it is determined in block 706 that the number of unexpected patterns is greater than MAX_UNEXPECTED, the flow proceeds to block 710, where the soft read is performed again with a larger voltage spacing (e.g., the difference in the read voltage value between two adjacent read voltages) than that/those of the initial read. From block 710, the flow proceeds back to block 702 where the flow continues until the number of unexpected results is less than MAX_UNEXPECTED, where the flow terminates at the end operation 708.

Referring to FIG. 8, a flow diagram 800 is shown illustrating a method to reduce the impact of read noise on soft reads in accordance with an example implementation of the present disclosure. The flow diagram 800 begins with block 802, which includes a soft decoding failure, such as by receiving an indication of a soft decoding failure, determining that a soft decoding failure has occurred, and the like. For example, the controller 102 determines that a soft decoding failure has occurred during a read process. From block 802, the flow proceeds to block 804, where the number of unexpected patterns is checked. From block 804, the flow proceeds to block 806, where it is determined whether the number of unexpected patterns is greater than MAX_UNEXPECTED (e.g., a maximum tolerable number of unexpected patterns for a particular LDPC code and decoder). When it is determined in block 806 that the number of unexpected patterns is less than MAX_UNEXPECTED, the flow proceeds to an end operation 808. When it is determined in block 806 that the number of unexpected patterns is greater than MAX_UNEXPECTED, the flow proceeds to block 810, where the results of one or more soft reads are discarded (e.g., decimated read voltages are used). For example, if an LSB page is read five times using read voltages V1 through V5 (from low to high), then the results of one ore more of the reads is discarded and the remainder of the reads are utilized. In the example of five read voltages, instead of using all five reads, the reads of V2 and V4 are discarded, with the results of V1, V3, and V5 being utilized. From block 810, the flow proceeds back to block 802 where the flow continues until the number of unexpected results is less than MAX_UNEXPECTED, where the flow terminates at the end operation 808. This can reduce the impact of read noise without having additional reads performed. In embodiments, the flows 700 and 800 are used separately or in combination.

Referring to FIG. 9, a system 900 includes a controller 902 operatively coupled with a memory 910. The controller 902, including some or all of its components, can operate under computer control. For example, a processor 904 can be included with or in a controller 902 to control the components and functions of systems 900 described herein using software, firmware, hardware (e.g., fixed logic circuitry), manual processing, or a combination thereof. The terms “controller,” “functionality,” and “logic” as used herein generally represent software, firmware, hardware, or a combination of software, firmware, or hardware in conjunction with controlling the system 900. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

A processor 904 provides processing functionality for the controller 902 and can include any number of processors, micro-controllers, or other processing systems, and resident or external memory for storing data and other information accessed or generated by the system 900. The processor 904 can execute one or more software programs that implement techniques described herein. The processor 904 is not limited by the materials from which it is formed or the processing mechanisms employed therein and, as such, can be implemented via semiconductor(s) and/or transistors (e.g., using electronic integrated circuit (IC) components), and so forth.

The controller 902 includes a communications interface 906. The communications interface 906 is operatively configured to communicate with components of the system 900. For example, the communications interface 906 can be configured to transmit data for storage in the system 900, retrieve data from storage in the system 900, and so forth. The communications interface 906 is also communicatively coupled with the processor 904 to facilitate data transfer between components of the system 900 and the processor 904 (e.g., for communicating inputs to the processor 904 received from a device communicatively coupled with the system 900). It should be noted that while the communications interface 906 is described as a component of a system 900, one or more components of the communications interface 906 can be implemented as external components communicatively coupled to the system 900 via a wired and/or wireless connection.

The communications interface 906 and/or the processor 904 can be configured to communicate with a variety of different networks including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to be restrictive of the present disclosure. Further, the communications interface 906 can be configured to communicate with a single network or multiple networks across different access points.

The controller 902 also includes a memory 908. The memory 908 is an example of tangible, computer-readable storage medium that provides storage functionality to store various data associated with operation of the controller 902, such as software programs and/or code segments, or other data to instruct the processor 904, and possibly other components of the controller 902, to perform the functionality described herein. Thus, the memory 908 can store data, such as a program of instructions for operating the controller 902 (including its components), and so forth. It should be noted that while a single memory 908 is described, a wide variety of types and combinations of memory (e.g., tangible, non-transitory memory) can be employed. The memory 908 can be integral with the processor 904, can comprise stand-alone memory, or can be a combination of both. The memory 908 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In embodiments of the disclosure that manifest in the form of integrated circuits, the various blocks discussed in the above disclosure can be implemented as integrated circuits along with other functionality. Such integrated circuits can include all of the functions of a given block, system, or circuit, or a portion of the functions of the block, system or circuit. Further, elements of the blocks, systems, or circuits can be implemented across multiple integrated circuits. Such integrated circuits can comprise various integrated circuits including, but not necessarily limited to: a system on a chip (SoC), a monolithic integrated circuit, a flip chip integrated circuit, a multichip module integrated circuit, and/or a mixed signal integrated circuit. In embodiments of the disclosure that manifest in the form of software, the various blocks discussed in the above disclosure represent executable instructions (e.g., program code) that perform specified tasks when executed on a processor. These executable instructions can be stored in one or more tangible computer readable media. In some such embodiments, the entire system, block or circuit can be implemented using its software or firmware equivalent. In some embodiments, one part of a given system, block or circuit can be implemented in software or firmware, while other parts are implemented in hardware.

Although embodiments of the disclosure have been described in language specific to structural features and/or methodological acts, it is to be understood that the subject matter defined in the appended claims is not necessarily limited to the specific embodiments described. Although various configurations are discussed, the apparatus, systems, subsystems, components and so forth can be constructed in a variety of ways without departing from teachings of this disclosure. Rather, the specific features and acts are disclosed as embodiments of implementing the claims.

What is claimed is:

1. A method for handling read noise on soft reads of a memory device comprising:
determining a number of unexpected patterns of a soft read of a memory cell after a soft decoding failure;
determining whether the number of unexpected patterns is greater than a threshold number of unexpected patterns; and
when it is determined that the number of unexpected patterns is greater than the threshold number of unexpected patterns, at least one of:
performing at least one more soft read of the memory cell with a larger read voltage spacing than an initial read that produced the soft decoding failure; and
discarding a result of one or more soft reads of the memory cell and utilizing a remainder of results of respective other soft reads of the memory.

2. The method as recited in claim 1, wherein when it is determined that the number of unexpected patterns is greater than the threshold number of unexpected patterns, performing at least one more soft read of the memory cell with a larger read voltage spacing than an initial read that produced the soft decoding failure.

3. The method as recited in claim 2, further comprising:
repeating the performing of at least one more soft read of the memory cell with a larger read voltage spacing until it is determined that the number of unexpected patterns is less than or equal to the threshold number of unexpected patterns.

4. The method as recited in claim 1, wherein when it is determined that the number of unexpected patterns is greater than the threshold number of unexpected patterns, discarding a result of one or more soft reads of the memory cell and utilizing a remainder of results of respective other soft reads of the memory.

5. The method as recited in claim 4, wherein the remainder of results of respective other soft reads of the memory includes decimated read voltage values.

6. The method as recited in claim 1, wherein when it is determined that the number of unexpected patterns is greater than the threshold number of unexpected patterns, the method includes each of:
performing at least one more soft read of the memory cell with a larger read voltage spacing than an initial read that produced the soft decoding failure; and
discarding a result of one or more soft reads of the memory cell and utilizing a remainder of results of respective other soft reads of the memory.

7. The method as recited in claim 1, further comprising:
setting a unique threshold number of unexpected patterns for a particular low density parity check code.

8. A non-transitory computer-readable medium having computer-executable instructions for performing a method for handling read noise on soft reads of a memory device, the method comprising:
determining a number of unexpected patterns of a soft read of a memory cell after a soft decoding failure;
determining whether the number of unexpected patterns is greater than a threshold number of unexpected patterns; and
when it is determined that the number of unexpected patterns is greater than the threshold number of unexpected patterns, at least one of:
performing at least one more soft read of the memory cell with a larger read voltage spacing than an initial read that produced the soft decoding failure; and
discarding a result of one or more soft reads of the memory cell and utilizing a remainder of results of respective other soft reads of the memory.

9. The non-transitory computer-readable medium as recited in claim 8, wherein when it is determined that the number of unexpected patterns is greater than the threshold number of unexpected patterns, the method includes performing at least one more soft read of the memory cell with a larger read voltage spacing than an initial read that produced the soft decoding failure.

10. The non-transitory computer-readable medium as recited in claim 9, wherein the method further comprises:
repeating the performing of at least one more soft read of the memory cell with a larger read voltage spacing until it is determined that the number of unexpected patterns is less than or equal to the threshold number of unexpected patterns.

11. The non-transitory computer-readable medium as recited in claim 8, wherein when it is determined that the number of unexpected patterns is greater than the threshold number of unexpected patterns, the method includes discarding a result of one or more soft reads of the memory cell and utilizing a remainder of results of respective other soft reads of the memory.

12. The non-transitory computer-readable medium as recited in claim 11, wherein the remainder of results of respective other soft reads of the memory includes decimated read voltage values.

13. The non-transitory computer-readable medium as recited in claim 8, wherein when it is determined that the number of unexpected patterns is greater than the threshold number of unexpected patterns, the method includes each of:
performing at least one more soft read of the memory cell with a larger read voltage spacing than an initial read that produced the soft decoding failure; and
discarding a result of one or more soft reads of the memory cell and utilizing a remainder of results of respective other soft reads of the memory.

14. The non-transitory computer-readable medium as recited in claim 8, wherein the method further comprises:
setting a unique threshold number of unexpected patterns for a particular low density parity check code.

15. A system for handling read noise on soft reads of a memory device, the system comprising:
a controller;
a memory communicatively coupled to the controller, the memory having computer executable instructions stored thereon, the computer executable instructions configured for execution by the controller to:
determine a number of unexpected patterns of a soft read of a memory cell after a soft decoding failure;
determine whether the number of unexpected patterns is greater than a threshold number of unexpected patterns; and
when it is determined that the number of unexpected patterns is greater than the threshold number of unexpected patterns, at least one of:
perform at least one more soft read of the memory cell with a larger read voltage spacing than an initial read that produced the soft decoding failure; and
discard a result of one or more soft reads of the memory cell and utilize a remainder of results of respective other soft reads of the memory.

16. The system as recited in claim 14, wherein when it is determined that the number of unexpected patterns is greater than the threshold number of unexpected patterns, the computer executable instructions are configured for execution to perform at least one more soft read of the memory cell with a larger read voltage spacing than an initial read that produced the soft decoding failure.

17. The system as recited in claim 16, wherein the computer executable instructions are further configured for execution to repeat the performing of at least one more soft read of the memory cell with a larger read voltage spacing until it is determined that the number of unexpected patterns is less than or equal to the threshold number of unexpected patterns.

18. The system as recited in claim 15, wherein when it is determined that the number of unexpected patterns is greater than the threshold number of unexpected patterns, the computer executable instructions are configured for execution to discard a result of one or more soft reads of the memory cell and utilize a remainder of results of respective other soft reads of the memory.

19. The system as recited in claim 18, wherein the remainder of results of respective other soft reads of the memory includes decimated read voltage values.

20. The system as recited in claim 15, wherein when it is determined that the number of unexpected patterns is greater than the threshold number of unexpected patterns, the computer executable instructions are configured for execution to:
perform at least one more soft read of the memory cell with a larger read voltage spacing than an initial read that produced the soft decoding failure; and
discard a result of one or more soft reads of the memory cell and utilize a remainder of results of respective other soft reads of the memory.
